(19) United States
(12) Patent Application Publication
(10) Pub. No.: US 2025/0170984 A1
(43) Pub. Date: May 29, 2025

(54) SMART BUCKLE SYSTEM

(71) Applicant: Indiana Mills & Manufacturing, Inc., Westfield, IN (US)

(72) Inventors: Shirish Vatkar, Noblesville, IN (US); Brian Nelson Coffman, Westfield, IN (US)

(73) Assignee: Indiana Mills & Manufacturing, Inc., Westfield, IN (US)

(21) Appl. No.: 19/041,166

(22) Filed: Jan. 30, 2025

Related U.S. Application Data
(63) Continuation of application No. PCT/US2023/071976, filed on Aug. 10, 2023.
(60) Provisional application No. 63/370,968, filed on Aug. 10, 2022.

(51) Int. Cl. B60R 22/48; B60N 2/00; B60R 22/10; B60R 22/18; B60R 22/46

(52) U.S. Cl. CPC B60R 22/48; B60N 2/002; B60R 22/105; B60R 22/18; B60R 22/46; B60R 2022/1806; B60R 2022/4816; B60R 2022/4841; B60R 2022/4866

(57) ABSTRACT

A safety monitoring system for a child safety includes a harness, buckle, buckle sensor, and tension sensor. The buckle sensor monitors status of the buckle. A harness adjuster adjusts tension of the harness. The tension sensor monitors the tension to the harness. An output device is located on the buckle. The output device provides the status of the buckle and tension of the harness. The system can include several types of sensors that are independent of a vehicle or a seat assembly. In one form, the buckle includes a strain gauge, temperature sensor, microphone, camera, thermometer, accelerometer, and/or gyroscope. A microprocessor and/or a wireless transceiver are located inside the buckle. The wireless transceiver facilitates communication between the restraint system, the sensors, and/or a computational device such as a smartphone. Data from the sensors may be partially or fully processed by the microprocessor in the buckle or the external computational device.

### CROSS REFERENCE TO RELATED APPLICATIONS

This application is a continuation of International Patent Application Number PCT/US2023/071976, filed Aug. 10, 2023, which is hereby incorporated by reference. International Patent Application Number PCT/US2023/071976, filed Aug. 10, 2023, claims the benefit of U.S. Patent Application No. 63/370,968, filed Aug. 10, 2022, which are hereby incorporated by reference.

### BACKGROUND

Child safety seats are now typically mandated for most children under a specified age and/or size. These child safety seat systems have saved countless lives. Child restraint harnesses are commonly used in child safety seats, but if the harness is not properly used injuries may occur.

Thus, there is a need for improvement in this field.

### SUMMARY

A unique child safety system has been developed to address the previously mentioned issues as well as other issues. The system is configured to provide to an individual the status of a seat occupant, such as a child or baby, in a child safety seat. Although some are integrated into seats of a vehicle, most child safety seats are sold as an aftermarket product. Commonly, the child safety seat includes one or more belts in the form of webbing and one or more latch plates with tongues that are coupled together at a buckle to form a harness. In one example, the buckle includes an output device, such as in the form of one or more indicator lights, that provide the status of the child safety seat. By being located on the buckle, the indicator lights are readily visible to a user. In one example, the indicator lights or other output devices indicate whether the latch plates are properly secured to the buckle or not.

The system is further configured to sense the tension being applied to the harness. If the tension of the harness is too low, the harness may not properly restrain the seat occupant during an accident. Conversely, the harness can become uncomfortable if the harness is too tight. In one version, an indicator light indicates whether the proper tension in the harness was achieved and/or the amount of tension in the harness. The tension sensor is configured to be readily adaptable to existing harness adjuster systems. The tension sensor is able to be placed underneath the seat. A harness adjuster strap of the harness adjuster is then routed over the tension sensor without needing to be severed or otherwise redesigned.

In some cases, the system further includes a seat occupancy sensor to indicate if the child safety seat is occupied and/or if the occupant is seated properly. In one form, the buckle includes an indicator light that indicates the occupancy status based on the seat occupancy sensor. A child may be too light or too heavy for a particular child seat, and the indicator light can provide an indication if those situations occur. The occupancy indicator can further alert an individual if the child attempts to or successfully slips out of the seat. The occupancy indicator can also alert the user of a child being left in the vehicle.

This system further relates generally to buckle systems for occupant seats in vehicles, and more specifically to a smart buckle system having an integrated sensor technology and/or an accompanying restraint system. The described and illustrated system may include one or more of the following features or any combinations thereof. In one aspect, a combination of a smart buckle and external and/or internal hardware for a vehicle seat is provided. The combination may include a buckle having a camera and/or a microphone extending out of the buckle. One or more portions of the smart buckle system may extend into an anchor box. The buckle may house one or more thermal sensors, one or more indicator lights, and/or one or more latch detection sensors. The buckle and/or restraint system may further include a strain and/or a tension gauge system, an accelerometer, a gyroscope, a thermometer, and/or a plurality of electrical components to receive, process, and/or export data to, but not limited to, an external application running on a separate mobile computational device. These components in one example are attached to a power source as well as a microprocessor and/or a transceiver for media integration capabilities.

The systems and techniques as described and illustrated herein concern a number of unique and inventive aspects. Some, but by no means all, of these unique aspects are summarized below.

Aspect 1 generally concerns a system.

Aspect 2 generally concerns the system of any previous aspect including a smart buckle system.

Aspect 3 generally concerns the system of any previous aspect including a child safety seat.

Aspect 4 generally concerns the system of any previous aspect including a seat assembly.

Aspect 5 generally concerns the system of any previous aspect including a seat back.

Aspect 6 generally concerns the system of any previous aspect including a seat bottom.

Aspect 7 generally concerns the system of any previous aspect including a restraint system.

Aspect 8 generally concerns the system of any previous aspect including a harness.

Aspect 9 generally concerns the system of any previous aspect in which the harness includes a five-point harness.

Aspect 10 generally concerns the system of any previous aspect in which the harness includes one or more belts.

Aspect 11 generally concerns the system of any previous aspect including a buckle.

Aspect 12 generally concerns the system of any previous aspect in which the harness includes one or more latch plates.

Aspect 13 generally concerns the system of any previous aspect in which the latch plates include a tongue.

Aspect 14 generally concerns the system of any previous aspect in which the latch plates are coupled to the belts.

Aspect 15 generally concerns the system of any previous aspect in which the latch plates are configured to be detachably secured to the buckle.

Aspect 16 generally concerns the system of any previous aspect in which the buckle includes a release button configured to release the latch plates from the buckle.

Aspect 16 generally concerns the system of any previous aspect in which the restraint system includes a harness adjuster.

Aspect 17 generally concerns the system of any previous aspect in which the harness adjuster being configured to adjust tension of the harness.

Aspect 18 generally concerns the system of any previous aspect in which the harness adjuster includes a harness adjuster strap.

Aspect 19 generally concerns the system of any previous aspect in which the harness adjuster includes a cam buckle configured to secure the harness adjuster strap.

Aspect 20 generally concerns the system of any previous aspect in which the restraint system includes a splitter plate.

Aspect 21 generally concerns the system of any previous aspect in which the splitter plate connecting the harness adjuster strap to the harness.

Aspect 22 generally concerns the system of any previous aspect in which the splitter plate connects the harness adjuster strap to the belts.

Aspect 23 generally concerns the system of any previous aspect in which the seat monitoring system.

Aspect 24 generally concerns the system of any previous aspect in which the seat monitoring system including a controller.

Aspect 25 generally concerns the system of any previous aspect in which the controller includes a processor.

Aspect 26 generally concerns the system of any previous aspect in which the controller includes memory.

Aspect 27 generally concerns the system of any previous aspect in which the memory is operatively coupled to the processor.

Aspect 28 generally concerns the system of any previous aspect in which the controller includes a power supply.

Aspect 29 generally concerns the system of any previous aspect in which the power supply includes an energy storage system (ESS).

Aspect 30 generally concerns the system of any previous aspect in which the ESS includes a battery.

Aspect 31 generally concerns the system of any previous aspect in which the power supply is configured to supply power to the processor.

Aspect 32 generally concerns the system of any previous aspect including an occupancy sensor (OCS).

Aspect 33 generally concerns the system of any previous aspect in which the occupancy sensor is located in the seat bottom.

Aspect 34 generally concerns the system of any previous aspect in which the occupancy sensor is a pressure sensor.

Aspect 35 generally concerns the system of any previous aspect in which the occupancy sensor is a weight sensor.

Aspect 36 generally concerns the system of any previous aspect in which the occupancy sensor is configured to sense if someone is sitting.

Aspect 37 generally concerns the system of any previous aspect in which the occupancy sensor is operatively coupled to the controller.

Aspect 38 generally concerns the system of any previous aspect in which the seat monitoring system includes a buckle sensor.

Aspect 39 generally concerns the system of any previous aspect in which the buckle sensor being configured to monitor status of the buckle.

Aspect 40 generally concerns the system of any previous aspect in which the tongue of at least one of the latch plates is configured to contact the buckle sensor when latched to the buckle.

Aspect 41 generally concerns the system of any previous aspect in which the buckle sensor includes a reed switch.

Aspect 42 generally concerns the system of any previous aspect in which the buckle sensor includes a micro switch.

Aspect 43 generally concerns the system of any previous aspect in which the micro switch includes a hinged spring.

Aspect 44 generally concerns the system of any previous aspect in which the hinged spring being configured to close the micro switch when the tongue presses against the hinged spring when latched.

Aspect 45 generally concerns the system of any previous aspect in which the buckle sensor is positioned inside the buckle.

Aspect 46 generally concerns the system of any previous aspect in which the buckle sensor is operatively coupled to the controller.

Aspect 47 generally concerns the system of any previous aspect in which the buckle sensor is operatively coupled to the processor.

Aspect 48 generally concerns the system of any previous aspect in which the buckle includes a buckle wire.

Aspect 49 generally concerns the system of any previous aspect in which the buckle wire operatively coupling the buckle sensor to the controller.

Aspect 50 generally concerns the system of any previous aspect in which the buckle has a buckle belt.

Aspect 51 generally concerns the system of any previous aspect in which the buckle belt secures the buckle to the child safety seat.

Aspect 52 generally concerns the system of any previous aspect in which the buckle wire is embedded in the buckle belt.

Aspect 53 generally concerns the system of any previous aspect in which the controller is mounted on a back side of the child safety seat.

Aspect 54 generally concerns the system of any previous aspect in which the buckle wire extends from the buckle to the back side of the child safety seat via the buckle belt.

Aspect 55 generally concerns the system of any previous aspect in which the seat monitoring system includes a tension sensor.

Aspect 56 generally concerns the system of any previous aspect in which the tension sensor being configured to monitor tension of the harness.

Aspect 57 generally concerns the system of any previous aspect in which the tension sensor is housed in the controller.

Aspect 58 generally concerns the system of any previous aspect in which the tension sensor being configured to monitor tension to the harness applied by the harness adjuster.

Aspect 59 generally concerns the system of any previous aspect in which the tension sensor is housed in the buckle.

Aspect 60 generally concerns the system of any previous aspect in which the tension sensor includes a strain gauge.

Aspect 61 generally concerns the system of any previous aspect in which the harness adjuster strap extends along the tension sensor.

Aspect 62 generally concerns the system of any previous aspect in which the tension sensor has a housing.

Aspect 63 generally concerns the system of any previous aspect in which the harness adjuster strap is configured to slide along the housing.

Aspect 64 generally concerns the system of any previous aspect in which the tension sensor includes a tension arm.

Aspect 65 generally concerns the system of any previous aspect in which the tension sensor includes a shaft upon which the tension arm is pivotally mounted.

Aspect 66 generally concerns the system of any previous aspect in which the tension arm has a surface where the harness adjuster strap contacts the tension arm.

Aspect 67 generally concerns the system of any previous aspect in which the harness adjuster strap is configured to pivot the tension arm when tension is applied.

Aspect 68 generally concerns the system of any previous aspect in which the tension sensor is configured to sense the tension in the harness adjuster strap when the tension arm pivots.

Aspect 69 generally concerns the system of any previous aspect in which the tension sensor includes a magnetic sensor.

Aspect 70 generally concerns the system of any previous aspect in which the magnetic sensor is a Hall effect sensor.

Aspect 71 generally concerns the system of any previous aspect in which the tension sensor includes a magnet.

Aspect 72 generally concerns the system of any previous aspect including a magnet mounted to the tension arm.

Aspect 73 generally concerns the system of any previous aspect in which the magnetic sensor is configured to measure the magnetic field from the magnet to determine the tension in the harness.

Aspect 74 generally concerns the system of any previous aspect in which the controller includes a circuit board.

Aspect 75 generally concerns the system of any previous aspect in which the processor and the memory are mounted on the circuit board.

Aspect 76 generally concerns the system of any previous aspect in which the magnetic sensor is mounted on the circuit board.

Aspect 77 generally concerns the system of any previous aspect in which the circuit board has a terminal to which the buckle wire is connected.

Aspect 78 generally concerns the system of any previous aspect in which the tension arm is biased against the harness adjuster strap.

Aspect 79 generally concerns the system of any previous aspect in which the tension sensor includes a spring configured to bias the tension arm against the harness adjuster strap.

Aspect 80 generally concerns the system of any previous aspect in which the spring includes a torsion spring.

Aspect 81 generally concerns the system of any previous aspect in which the torsion spring is wrapped around the shaft.

Aspect 82 generally concerns the system of any previous aspect in which the tensor sensor includes one or more strap guides.

Aspect 83 generally concerns the system of any previous aspect in which the strap guides are configured to guide the harness adjuster strap across the tension arm.

Aspect 84 generally concerns the system of any previous aspect in which the strap guides are positioned on opposite sides of the tension arm.

Aspect 85 generally concerns the system of any previous aspect in which the strap guides have guide arms that define a guide slot where the harness adjuster strap is received.

Aspect 86 generally concerns the system of any previous aspect in which the guide arms define a gap.

Aspect 87 generally concerns the system of any previous aspect in which the tension arm has one or more guide flanges.

Aspect 88 generally concerns the system of any previous aspect in which the guide flanges define a guide channel where the harness adjuster strap is received.

Aspect 89 generally concerns the system of any previous aspect in which the guide flanges are configured to minimize lateral movement of the harness adjuster strap.

Aspect 90 generally concerns the system of any previous aspect in which the seat monitoring system includes an output device.

Aspect 91 generally concerns the system of any previous aspect in which the output device being located on the buckle.

Aspect 92 generally concerns the system of any previous aspect in which the output device is located proximal to the release button of the buckle to enhance visibility.

Aspect 93 generally concerns the system of any previous aspect in which the output device is configured to provide the status of the buckle.

Aspect 94 generally concerns the system of any previous aspect in which the output device is configured to provide an indication of the tension of the harness.

Aspect 95 generally concerns the system of any previous aspect in which the output device is integrated into the controller.

Aspect 96 generally concerns the system of any previous aspect in which the output device includes a display.

Aspect 97 generally concerns the system of any previous aspect in which the output device includes a speaker.

Aspect 98 generally concerns the system of any previous aspect in which the output device includes one or more indicator lights.

Aspect 99 generally concerns the system of any previous aspect in which the indicator lights include light emitting diodes (LEDs).

Aspect 100 generally concerns the system of any previous aspect in which the indicator lights include a buckle indicator light.

Aspect 101 generally concerns the system of any previous aspect in which the buckle indicator light is configured to indicate status of the buckle.

Aspect 102 generally concerns the system of any previous aspect in which the buckle indicator light is configured to indicate if the latch plates are secured to the buckle.

Aspect 103 generally concerns the system of any previous aspect in which the indicator lights include a tension indicator light.

Aspect 104 generally concerns the system of any previous aspect in which the tension indicator light indicates if the harness is properly tensioned.

Aspect 105 generally concerns the system of any previous aspect in which the tension indicator light indicates the level of tension in the harness.

Aspect 106 generally concerns the system of any previous aspect in which the indicator lights include an occupancy indicator light.

Aspect 107 generally concerns the system of any previous aspect in which the occupancy indicator light indicates if someone is sitting in the seat.

Aspect 108 generally concerns the system of any previous aspect in which the occupancy indicator light indicates weight.

Aspect 109 generally concerns the system of any previous aspect in which the indicator lights are configured to change color to indicate status.

Aspect 110 generally concerns the system of any previous aspect in which the indicator lights are configured to change brightness to indicate status.

Aspect 111 generally concerns the system of any previous aspect in which the seat monitoring system includes a microphone.

Aspect 112 generally concerns the system of any previous aspect in which the microphone is integrated into the buckle.

Aspect 113 generally concerns the system of any previous aspect in which the microphone is configured to monitor for sounds from an occupant of the seat.

Aspect 114 generally concerns the system of any previous aspect in which the seat monitoring system includes a camera.

Aspect 115 generally concerns the system of any previous aspect in which the camera being integrated into the buckle.

Aspect 116 generally concerns the system of any previous aspect in which the camera is configured to facilitate visual monitoring of an occupant of the seat.

Aspect 117 generally concerns the system of any previous aspect in which the seat monitoring system includes a temperature sensor.

Aspect 118 generally concerns the system of any previous aspect in which the temperature sensor being integrated into the buckle.

Aspect 119 generally concerns the system of any previous aspect in which the temperature sensor is configured to measure seat temperature.

Aspect 120 generally concerns the system of any previous aspect in which the buckle includes a transceiver.

Aspect 121 generally concerns a method.

Aspect 122 generally concerns the method of any previous aspect including detecting buckling of a harness with a buckle sensor.

Aspect 123 generally concerns the method of any previous aspect including providing with an output device a buckle indication in response to the detecting buckling.

Aspect 124 generally concerns the method of any previous aspect including measuring tension of the harness with a tension sensor.

Aspect 125 generally concerns the method of any previous aspect including providing with the output device a tension indication that corresponds with the tension of the harness.

Aspect 126 generally concerns the method of any previous aspect including determining a seat was occupied with an occupancy sensor.

Aspect 127 generally concerns the method of any previous aspect including providing with the output device an occupancy indication.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a front view of a smart buckle system according one example.

FIG. 2 is a front view of a camera used in the FIG. 1 smart buckle system.

FIG. 3 is a block diagram of a seat monitoring system according to another example.

FIG. 4 is a front view of a child safety seat that incorporates the FIG. 3 seat monitoring system.

FIG. 5 is a rear view of the FIG. 4 child safety seat.

FIG. 6 is a front view of a buckle used in the FIG. 4 child safety seat.

FIG. 7 is a perspective view of the FIG. 6 buckle.

FIG. 8 is an enlarged top view of latch plates engaging a buckle sensor in the FIG. 6 buckle.

FIG. 9 is a bottom perspective view of the FIG. 4 child safety seat with a controller secured to the seat bottom of the child safety seat.

FIG. 10 is a perspective view of the FIG. 9 controller.

FIG. 11 is a bottom view of the FIG. 9 controller.

FIG. 12 is a bottom perspective view of a tension sensor in the FIG. 9 controller.

FIG. 13 is a top perspective view of the FIG. 12 tension sensor.

FIG. 14 is a side view of the FIG. 12 tension sensor during use.

FIG. 15 is a perspective view of the FIG. 12 tension sensor during use.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

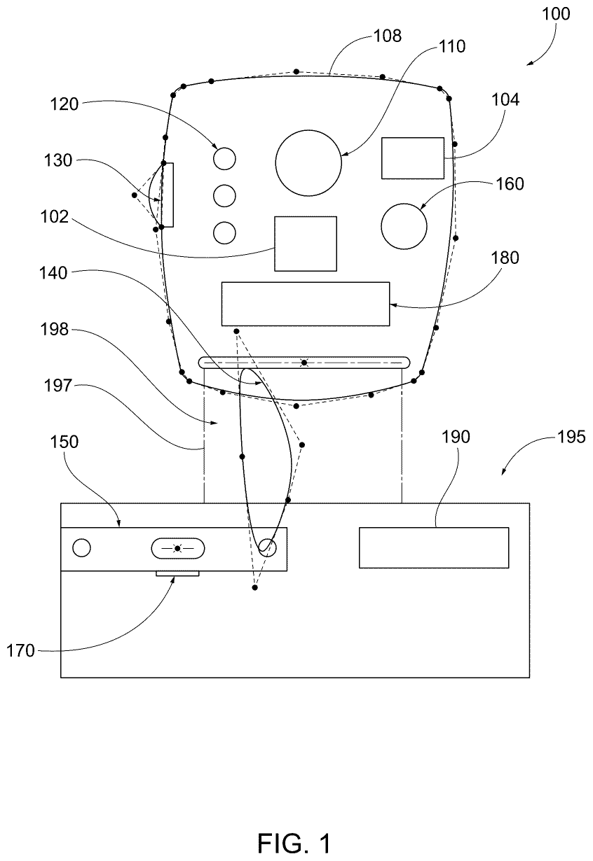

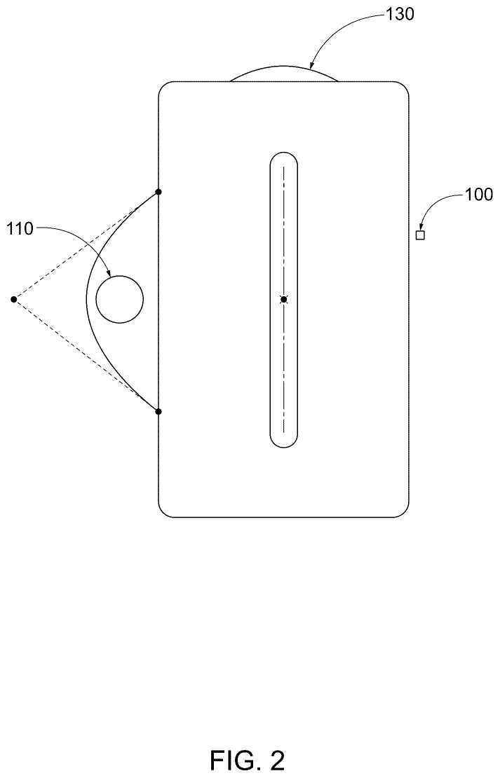

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

Referring now to FIG. 1, an embodiment is shown of a smart buckle system 100. The smart buckle system 100 is provided with a combination of sensors, cameras, microprocessors, and/or other components for media integration technologies.

The smart buckle system 100 shown in FIG. 1 is equipped with a microprocessor 102 and a transceiver 104 that are integrated inside of a buckle 108. The microprocessor 102 and the transceiver 104 may be installed on one or more circuit boards fitted within the buckle 108. Any of the accompanying sensors mentioned below may also be installed on one or more of the circuit boards fitted within the buckle 108 of the smart buckle system 100. In the illustrated example, the smart buckle system 100 includes a camera 110, one or more indicator lights 120, a microphone 130, a connector 140, a load sensor 150, a temperature sensor 160, a tension sensor 170, and a thermal sensing electronic device 180.

The smart buckle system 100 in the illustrated embodiment is designed for use with an accompanying restraint system. In one example, the restraint system includes one or more sensors that are connected to and/or processed by the microprocessor 102 of smart buckle system 100. The microprocessor 102 in one variation is used to interpret and/or simplify data coming from multiple sensors within the smart buckle system 100 and/or the accompanying restraint system. The microprocessor 102 in one form is configured to organize the data into useful information that can be accessed by the user via an external mobile computational device such as a smartphone. The microprocessor 102 as well as all other components in the buckle 108 are powered by an external power source 190, such as an external battery, located in an external enclosure 195 that is external to the buckle 108. The microprocessor 102 is configured to send processed data to the transceiver 104 that can communicate with common external computational devices such as mobile phones or tablets. In one variation, the transceiver 104 is configured to transmit the data to an application on the external computational device to be further processed by the application.

All or part of the thermal sensing electronic device 180 may be located inside the buckle 108 and/or the accompanying restraint system. In one form, the thermal sensing electronic device 180 is configured to send one or more digital and/or analog electrical signals to the microprocessor 102. In one example, the inside of the buckle 108 and/or the accompanying restraint system may further include an accelerometer sensor that is configured to send one or more digital and/or analog electrical signals from three different axes to the microprocessor 102. In another example, the inside of the buckle 108 and/or the accompanying restraint system may further include a gyroscope, which is configured to send one or more digital and/or analog electrical signals from three different axes to the microprocessor 102. In the illustrated embodiment, the inside of the buckle 108 and/or the accompanying restraint system may also include the camera 110, which is configured to send digital and/or analog optical data or live imagery data to the microprocessor 102. The inside of the buckle 108 and/or the accompanying restraint system may also include the microphone 130, which is configured to send digital and/or analog audio signals to the microprocessor 102.

In one example, the accelerometer sensor, which is located within the buckle 108, is configured to send digital and/or analog electrical signals to the microprocessor 102 to be organized into useful information for the user. This data can be accessed via the external application running on the separate computational device. The information provided for the user may include metrics on speed of the vehicle that has the smart buckle system 100, movement detection within the smart buckle system 100, and/or orientation of the buckle 108.

In a further example, the temperature sensor 160 is incorporated within the buckle 108. The temperature sensor 160 is configured to monitor the temperature of the buckle 108 as well as the air or ambient temperature surrounding the buckle 108. The temperature data in one example is sent to the microprocessor 102 so as to be organized into useful information for the user. The temperature data can be accessed via the external application running on the separate mobile computational device.

In one embodiment, the external power source 190 is housed inside of the floor anchor for the accompanying seat or restraint system. In one form, the power source is a rechargeable lithium battery or other equivalent long-lasting battery that is designed to fit easily into the floor anchor. The power source provides necessary power for the electronics within the buckle 108. Any sensors or other electronic components within the accompanying restraint system may also be powered by the power source.

In one version, the plurality of electronic components within the buckle 108 or the accompanying restraint system are configured to transfer electrical signals across a webbing 197 of the accompanying restraint system for much of its communication between devices. The webbing 197 used within the smart buckle system 100 or the accompanying restraint system carries electronic signals through at least one wire 198 that is sewn and/or woven directly into the webbing 197. The wire 198 in the webbing 197 carries sensor data and processed microcontroller data. The wire 198 in the webbing 197 in selected embodiments is further configured to supply power from the external power source 190.

The buckle 108 and/or the accompanying restraint system houses the camera 110 and/or other occupant viewing devices that monitor the user of the smart buckle system 100. The image or video data from the camera 110 is sent to the microprocessor 102 for relaying to the user via the external application running on the separate mobile computational device.

The microphone 130 in one form is located inside the buckle 108 and/or incorporated into the accompanying restraint system. The microphone 130 is configured to record at certain sound frequencies. The resulting sound data from the microphone 130 is sent to the microprocessor 102. The sound data from the microphone 130 is processed into useful information for the user via the external application running on the separate mobile computational device.

The smart buckle system 100 and/or the accompanying restraint system in one embodiment include the indicator lights 120. These indicator lights 120 are configured to indicate one or more conditions such as, but not limited to, proper tongue latching, acceptable tension loads, and/or acceptable temperatures. This data may be further sent to the microprocessor 102 and processed into useful information for the user via the external application running on the separate mobile computational device.

The load sensor 150 and/or the tension sensor 170 in one embodiment are located within the buckle 108 and/or the accompanying restraint system. The load sensor 150 and/or the tension sensor 170 are connected at one end of the connector 140 that is opposite to the buckle 108. The data from the load sensor 150 and/or the tension sensor 170 in one version are sent to the microprocessor 102 and processed into useful information for the user via the external application running on the separate mobile computing device.

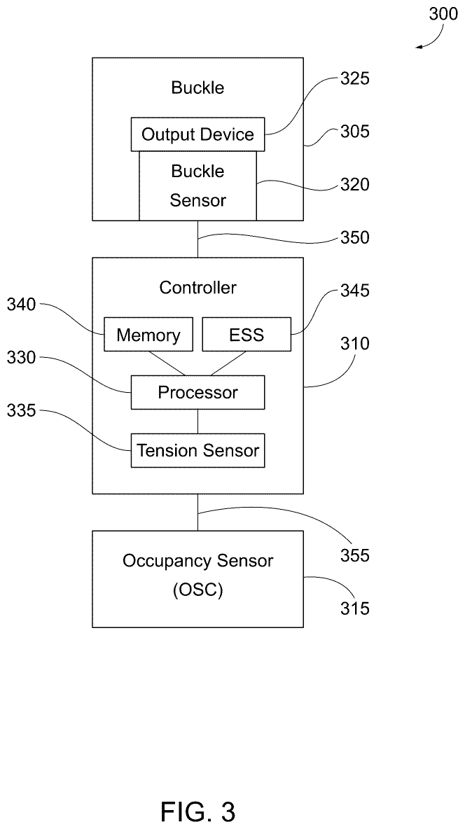

FIG. 3 depicts a block diagram of a seat monitoring system 300 according to another example. As shown, the seat monitoring system 300 includes a buckle 305, a controller 310, and an occupancy sensor (OCS) 315 operatively connected to one another. The seat monitoring system 300 is configured to sense whether a seat occupant is properly secured in a child seat restraint system as well as provide other information. The buckle 305 includes a buckle sensor 320 configured to sense if the buckle 305 is buckled properly and an output device 325 is configured to indicate the status of the buckle 305 as well provide other information.

In the illustrated example, the controller 310 includes a processor 330, a tension sensor 335 operatively coupled to the processor 330, memory 340 operatively coupled to the processor 330, and an energy Storage System (ESS) 345 configured to provide electrical power to the controller 310 as well as the other components in the seat monitoring system 300. The tension sensor 335 is configured to sense the tension of the restraint system to determine if the seat occupant is properly secured. Among other things, the processor 330 processes the status information from the occupancy sensor 315, the buckle sensor 320, and the tension sensor 335, and based on this information, the processor 330 provides the status of the restraint system to a user via the output device 325. For example, the processor 330 of the controller 310 can indicate whether the buckle 305 is buckled properly via the output device 325. The controller 310 can indicate whether the restraint system is properly tensioned via the output device 325 as well as whether the seat is occupied. Among other things, the memory 340 is used to store safety operational limits or ranges used by the processor 330. For instance, the memory 340 can store proper tension ranges for the restraint system so that the controller 310 is able to indicate via the output device 325 whether the seat occupant is properly secured. The ESS 345 is operatively coupled to the processor 330 so as to provide power to the buckle 305, controller 310, and occupancy sensor 315. In one form, the ESS 345 is a portable type power supply, such as in the form of a battery and/or super capacitor, and in other forms, the ESS 345 is a hardwired power source directly connected to the electrical power supply of the vehicle.

The occupancy sensor 315 senses whether an occupant is seated in the seat via how much force is being applied to the occupancy sensor 315 which is indicative of the weight and/or position of the seat occupant. For instance, the occupancy sensor 315 can be located in a seat bottom to sense weight and/or pressure. In other variations, the seat monitoring system 300 does not include the occupancy sensor 315 such that the seat monitoring system 300 only includes the buckle sensor 320 and tension sensor 335.

The buckle 305 is operatively connected to the controller 310 via a buckle wire 350, and the occupancy sensor 315 is operatively connected to the controller 310 via an occupancy sensor wire 355. It should be recognized that the components of the seat monitoring system 300 can be operatively coupled together in other manners or ways. For instance, the components of the seat monitoring system 300 can be operatively coupled together via fiber optic cables and/or wirelessly. In another variation, the buckle 305 and controller 310 are integrated together to form a single unit, and in other variations, the tension sensor 335 is incorporated into the buckle 305. The seat monitoring system 300 in still yet other variations includes fewer or more sensors as well as other components than is illustrated in FIG. 3.

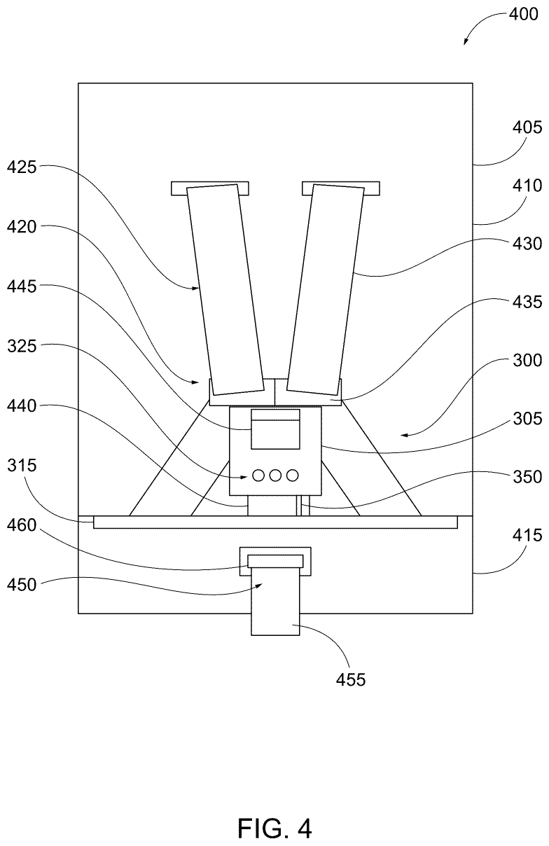

FIG. 4 shows one example of a child safety seat 400 that can incorporate the seat monitoring system 300 of FIG. 3. As shown, the child safety seat 400 includes a seat assembly 405 where a seat occupant, such as a baby or child, can sit. The seat assembly 405 includes a seat back 410 and a seat bottom 415 extending from one end of the seat back 410. In the depicted example, the occupancy sensor 315 is located inside the cushion that in part forms the seat bottom 415 of the seat assembly 405.

The child safety seat 400 further includes a restraint system 420 that is configured to safely restrain the seat occupant such as during a collision or other accident. In one form, the restraint system 420 includes a harness 425 with one or more belts 430 that secure the seat occupant. The belts 430 have one or more latch plates 435 that are configured to latch with the buckle 305. The buckle 305 is secured to the seat bottom 415 of the child safety seat 400 via a buckle belt 440. In the depicted example, the harness 425 is in the form of a five-point type harness, but other types of harnesses can be used.

To provide easy visibility, the buckle 305 has the output device 325 facing outward to the user. The buckle wire 350, which operatively connects the buckle 305 to the controller 310, is woven into or otherwise incorporated into the buckle belt 440 in the illustrated embodiment. This allows the buckle wire 350 to readily run through the child safety seat 400 to the backside of the child safety seat 400 where the controller 310 is mounted. The buckle 305 has a release button 445 that is used to unbuckle or unlatch that latch plates 435 from the buckle 305 so that the seat occupant can be removed from the child safety seat 400.

To loosen or tighten the belts 430 in the harness 425, the restraint system 420 further includes a harness adjuster 450. The harness adjuster 450 has a harness adjuster strap 455 that is configured to tighten the belts 430 of the harness 425 when pulled and to loosen the belts 430 when slackened. The harness adjuster 450 further includes a releasable cam buckle 460 that is configured to secure the harness adjuster strap 455 to maintain the tension in the belts 430 of the harness 425. The cam buckle 460 is actuated to release the harness adjuster strap 455 so as to slacken the harness adjuster strap 455 which in turn releases tension in the belts 430 of the harness 425. It should be recognized that other types of harness adjusters 450 can be used in other examples.

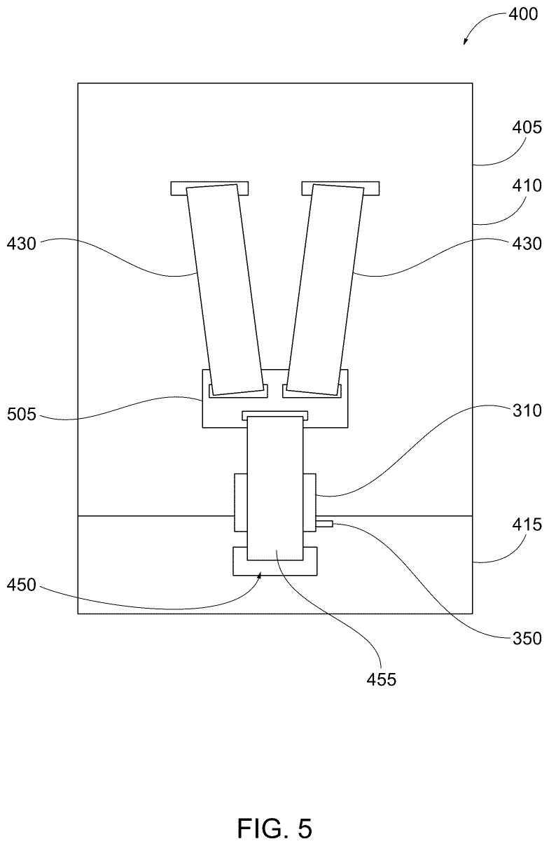

FIG. 5 shows the back of the child safety seat 400. As can be seen, the controller 310 is mounted on the backside of the child safety seat 400. The buckle wire 350 in the buckle belt 440 from the buckle 305 extends through the child safety seat 400 so as to connect to the controller 310. The belts 430 and the harness adjuster strap 455 are connected together via a splitter plate 505. The harness adjuster strap 455 extends along the controller 310 so that the tension sensor 335 is able to measure the tension of the harness adjuster strap 455 which is indicative of the tension in the belts 430 of the harness 425.

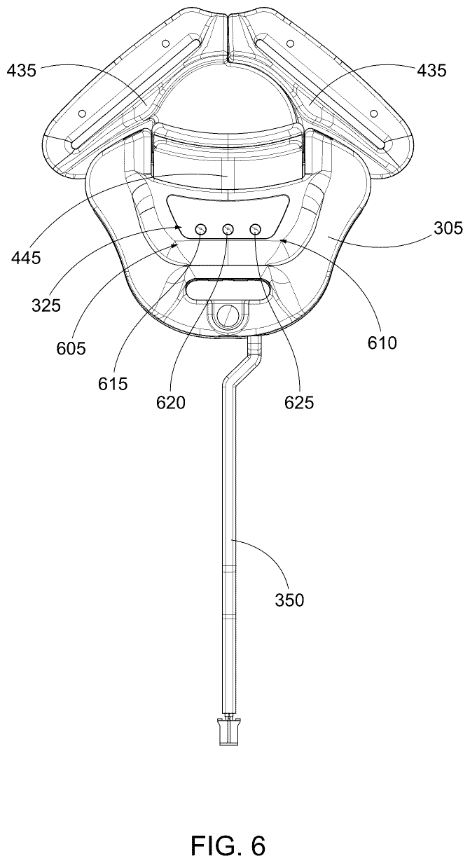

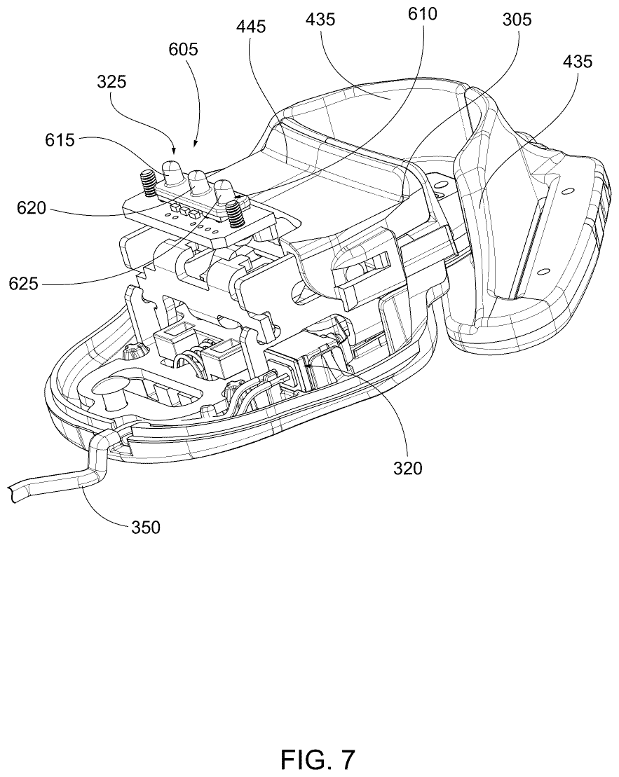

Turning to FIGS. 6 and 7, the buckle 305 has the output device 325 in the form of one or more indicator lights 605. The indicator lights 605 along with the buckle sensor 320 are operatively connected to the controller 310 via the buckle wire 350. The controller 310 is then able to control the indicator lights 605 based on the current status of the child safety seat 400. In the depicted example, the indicator lights 605 are in the form of multi-color light emitting diodes (LEDs) 610. The indicator lights 605 are positioned proximal to where the latch plates 435 engage the buckle 305 as well as where the release button 445 is used to unbuckle the latch plates 435. Having the indicator lights 605 positioned at such a location makes the output device 325 readily visible to the user so that the user can quickly discern whether the seat occupant is secured properly. In the illustrated example, each of the indicator lights 605 are indicative of the status of a particular sensor. The indicator lights 605 include a buckle indicator 615 that indicates whether the latch plates 435 are properly buckled via the buckle sensor 320. For instance, the buckle indicator 615 can be lit red to indicate that the latch plates 435 are not properly buckled and lit green to indicate that the latch plates 435 are properly buckled to the buckle 305. For this example, the buckle indicator 615 provides a binary output, but in other examples, the buckle indicator 615 can provide an analog or gradient type indication as to the extent to which the latch plates 435 are buckled with the buckle 305.

The indicator lights 605 further include an occupancy indicator 620 which indicates whether and/or to what extent the occupancy sensor 315 detects an occupant in the child safety seat 400. For example, the occupancy indicator 620 can display different colors depending on the weight or pressure applied to the occupancy sensor 315. In one particular example, the controller 310 lights the occupancy indicator 620 to red when no pressure is detected by the occupancy sensor 315. The occupancy indicator 620 is lit to have yellow color when some weight or pressure is detected, but the weight is below a particular threshold level stored in the memory 340 of the controller 310. The occupancy indicator 620 is lit green when the weight of the occupant is at or above the threshold. In another example, the occupancy indicator 620 is lit in a binary fashion. For instance, the occupancy indicator 620 is only lit when a seat occupant is detected.

The indicator lights 605 also include a tension indicator 625 that indicates the tension state of the belts 430 of the harness 425 sensed by the tension sensor 335. The tension indicator 625 can operate in a binary fashion where the tension indicator 625 is lit green when the harness 425 is properly tensioned and lit red when the harness 425 is not at the proper tension. In another variation, the tension indicator 625 is turned on only when the harness 425 is properly tensioned, and the tension indicator 625 is turned off when the harness 425 is not at the correct tension. In other variations, the intensity and/or color of the light varies in a general analog or gradient fashion depending on the tension of the harness adjuster strap 455.

It should be recognized that the buckle indicator 615, occupancy indicator 620, and tension indicator 625 can be positioned or arranged in a different order than illustrated. Moreover, other types of output devices such as displays and/or speakers can be used for the output device 325. For instance, the output device 325 in other variations can include a speaker that issues an audible alert depending on the status of the various sensors.

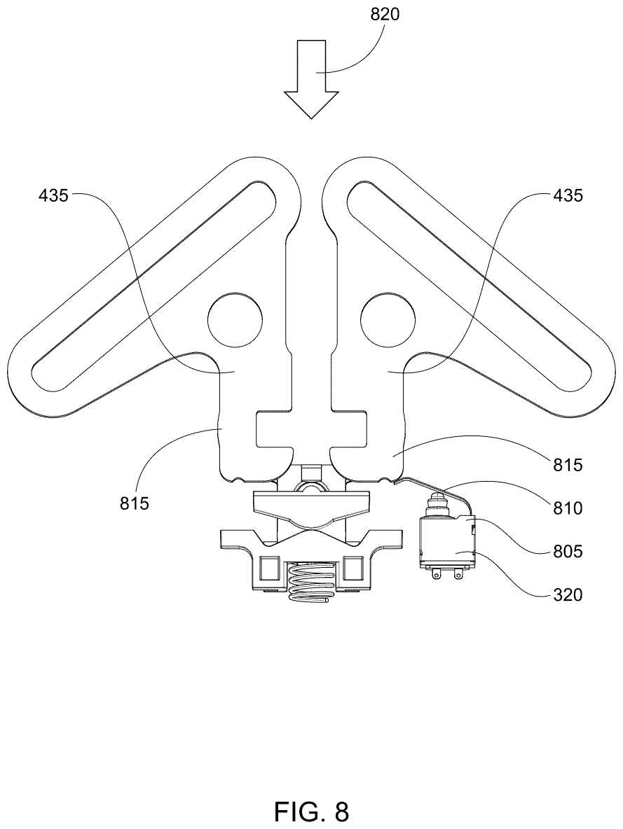

One example of the buckle sensor 320 during operation is depicted in FIG. 8. As can be seen, the buckle sensor 320 includes a micro switch 805 with a hinged spring 810 extending at an end proximal to the latch plates 435. The latch plates 435 each have a tongue 815 that is configured to latch with the buckle 305. The tongues 815 are inserted into the buckle 305 in the direction indicated by arrow 820. When the tongues 815 of the latch plates 435 are properly inserted and latched, at least one of the tongues 815 actuates or depresses the hinged spring 810 so as to close the micro switch 805. When the processor 330 of the controller 310 senses closure of the micro switch 805, the processor 330 activates the buckle indicator 615 on the controller 310 to indicate that the buckle 305 is correctly buckled. For instance, the buckle indicator 615 can glow a green color to indicate that the latch plates 435 are latched in the buckle 305. When the user presses the release button 445 on the buckle 305 to release and eject the latch plates 435, the end of the tongue 815 disengages from the hinged spring 810 of the micro switch 805 such that the micro switch 805 is opened. Upon sensing opening of the micro switch 805, the controller 310 changes the color and/or brightness of the buckle indicator 615 to indicate that the latch plates 435 are unbuckled from the buckle 305. For instance, the buckle indicator 615 can glow red or be turned off when the latch plates 435 are disengaged from the buckle 305.

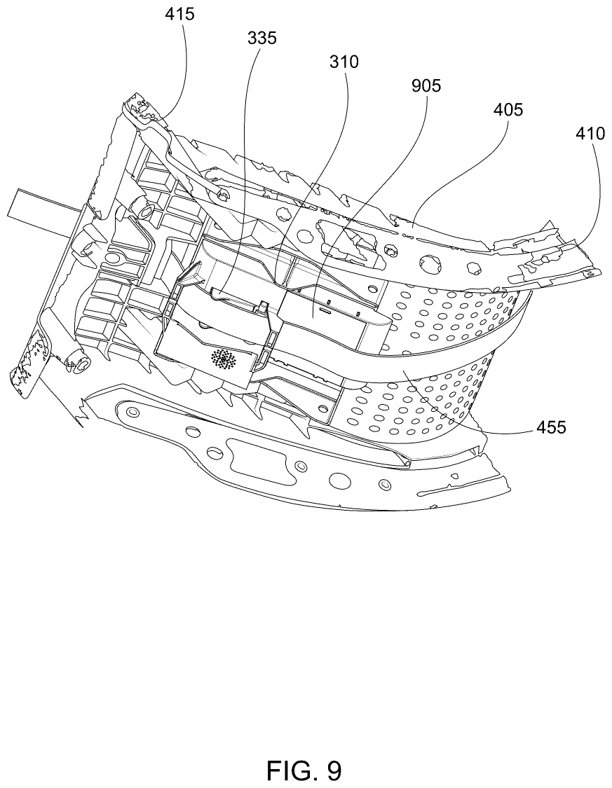

FIG. 9 shows one example of how the controller 310 is mounted underneath or on the backside of the seat assembly 405. As can be seen, the controller 310 is generally mounted at the seat bottom 415 of the seat assembly 405. The controller 310 has a housing 905 upon which the harness adjuster strap 455 extends. The harness adjuster strap 455 slides along the housing 905 of the controller 310 so as to engage the tension sensor 335. When tension is applied to the harness adjuster strap 455, the harness adjuster strap 455 presses against the tension sensor 335 which in turn senses the amount of tension being applied. It should be appreciated that such a configuration allows the tension sensor 335 to be implemented into existing harness adjuster designs with minimal changes. The harness adjuster strap 455 does not need to be severed or otherwise changed in order to include the tension sensor 335. The harness adjuster strap 455 just needs to be routed over the tension sensor 335.

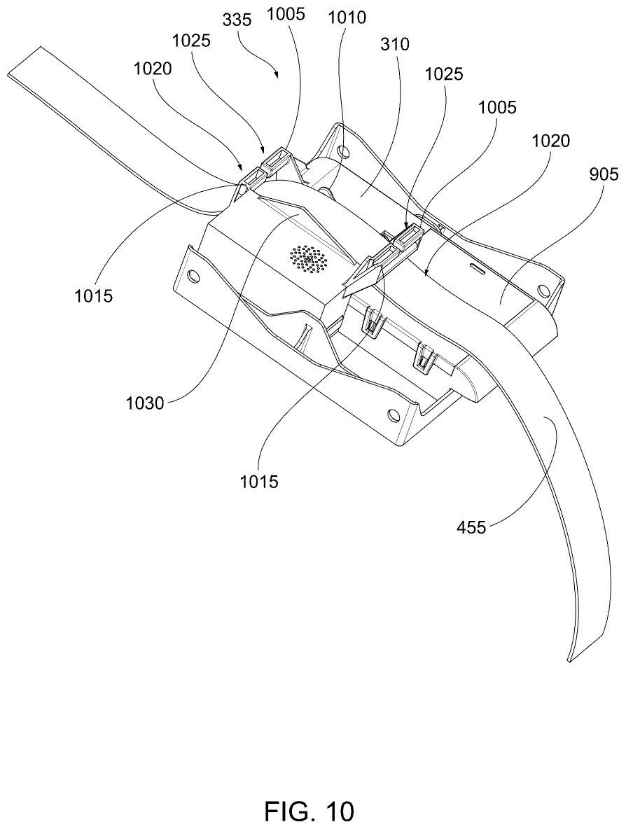

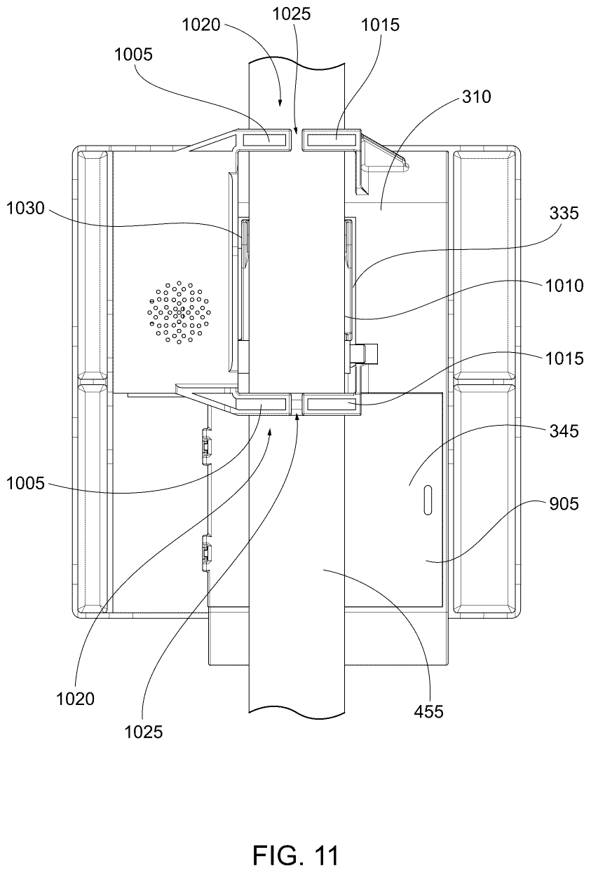

Referring to FIGS. 10 and 11, the housing 905 of the controller 310 has one or more strap guides 1005 that guide the harness adjuster strap 455 over the tension sensor 335. The tension sensor 335 includes a tension arm 1010 over which the harness adjuster strap 455 slides in a longitudinal direction. In the depicted example, the controller 310 has two strap guides 1005 positioned on opposite sides of the tension arm 1010 of the tension sensor 335. The strap guides 1005 are designed to minimize the risk of the harness adjuster strap 455 disengaging from the tension arm 1010 of the tension sensor 335. The strap guides 1005 include one or more guide arms 1015 that define a guide slot 1020 through which the harness adjuster strap 455 extends. In the illustrated example, each strap guide 1005 has two guide arms 1015 that are spaced from one another to form a gap 1025 where the harness adjuster strap 455 can be inserted or removed during assembly, repair, and maintenance. The strap guides 1005 can have a different number of guide arms 1015 in other examples. Where the harness adjuster strap 455 rides over the tension arm 1010, the tension arm 1010 has one or more guide flanges 1030. In the depicted example, the guide flanges 1030 are located on opposite lateral sides of the harness adjuster strap 455. The guide flanges 1030 are configured to reduce the risk of the harness adjuster strap 455 sliding in a lateral direction off from the tension arm 1010.

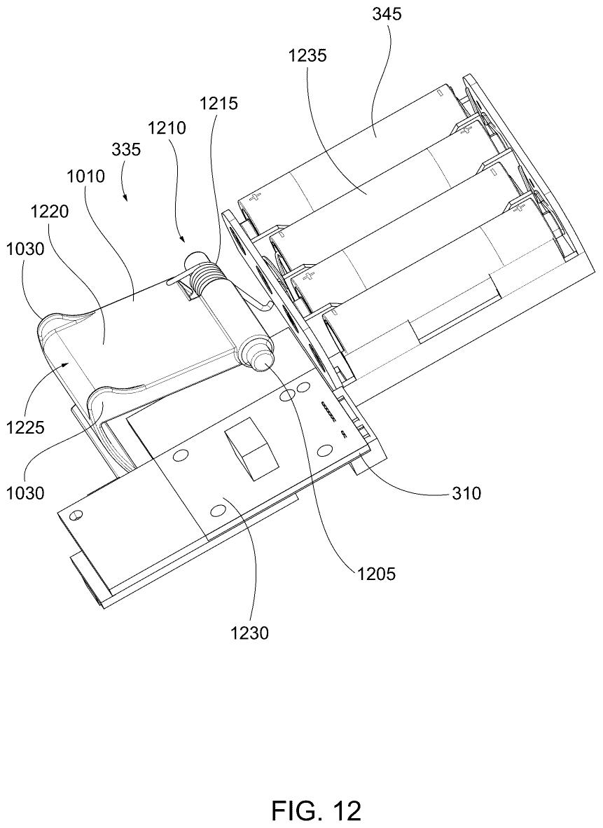

Looking at FIG. 12, the tension arm 1010 is pivotally mounted to a shaft 1205 that is secured to the housing 905 of the controller 310. To bias the tension arm 1010 to engage the harness adjuster strap 455, the tension sensor 335 further includes a spring 1210. In the illustrated example, the spring 1210 includes a torsion spring 1215 that is wrapped around the shaft 1205. The torsion spring 1215 is engaged between the housing 905 of the controller 310 and the tension arm 1010 so as to bias the tension arm 1010 in an outward direction to engage the harness adjuster strap 455. In other examples, different types of springs or other devices can be used. The tension arm 1010 has a guide surface 1220 against which the harness adjuster strap 455 slides. The guide flanges 1030 and guide surface 1220 of the tension arm 1010 define a guide channel 1225 where the harness adjuster strap 455 is received. The guide channel 1225 helps to align and guide the harness adjuster strap 455 over the tension arm 1010.

As further shown in FIG. 12, the controller 310 further includes a circuit board 1230 where the processor 330, memory 340, and other components of the controller 310 are mounted. In the illustrated embodiment, the ESS 345 includes one or more batteries 1235, but the child safety seat 400 can be powered based on other power sources such as via electrical power from the vehicle. The electronic components on the circuit board 1230 as well as the other components of the seat monitoring system 300 are powered by the batteries 1235.

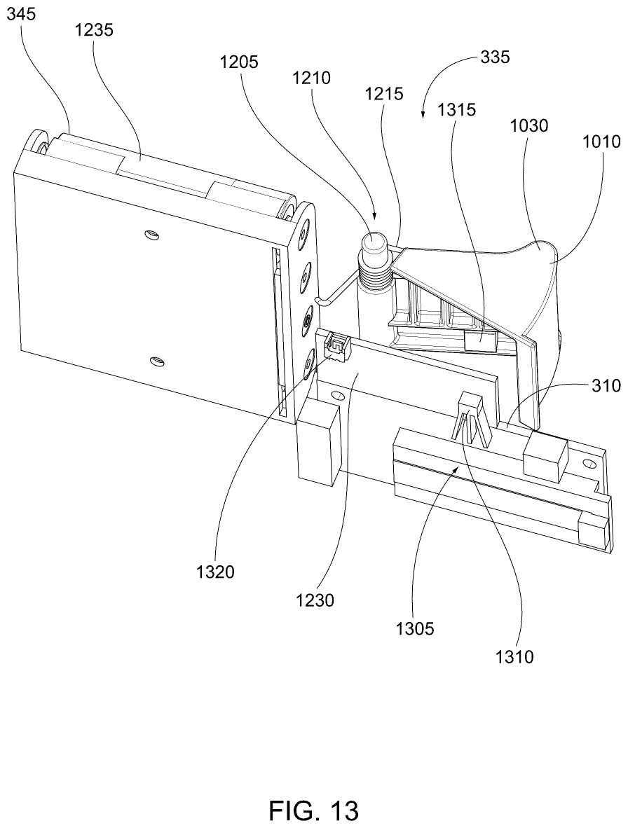

The tension of the harness 425 is determined based on the extent the tension arm 1010, which is biased by the spring 1210, is deflected by the harness adjuster strap 455 pressing against the guide surface 1220 of the tension arm 1010. As shown in FIG. 13, the tension sensor 335 includes a magnetic sensor 1310 that determines if and how far the tension arm 1010 is pivoted about the shaft 1205 by the harness adjuster strap 455. The sensor 1305 in the illustrated example includes a magnetic sensor 1310, such as a Hall effect sensor, that determines the relative position of the tension arm 1010 based on the magnetic field strength from a permanent magnet 1315 secured to the inside of the tension arm 1010. it should be recognized that other types of sensors, such as infrared (IR) and contact sensors, can be used to sense the relative position of the tension arm 1010. As can be seen, the magnetic sensor 1310 is mounted to the circuit board 1230. The circuit board 1230 further includes one or more terminals 1320 where the buckle 305 and/or the occupancy sensor 315 are operatively connected to the controller 310 via the buckle wire 350 and/or occupancy sensor wire 355.

When tension is applied to the harness adjuster strap 455, the tension arm 1010 pivots about the shaft 1205 against the force of the torsion spring 1215. As the magnet 1315 on the tension arm 1010 moves closer to the magnetic sensor 1310 on the circuit board 1230, the magnetic sensor 1310 senses a stronger magnetic field. The processor 330 of the controller 310 correlates the stronger magnetic field to a stronger tension being applied to the harness 425. Conversely, when the tension in the harness adjuster strap 455 is released, such as when the cam buckle 460 is actuated to release the harness adjuster strap 455, the spring 1210 of the tension sensor 335 pivots the magnet 1315 on the tension arm 1010 away from the magnetic sensor 1310. This causes the magnetic sensor 1310 to sense a weaker magnetic field. The processor 330 of the controller 310 interprets the weaker magnetic field to weaker tension being applied to the harness 425.

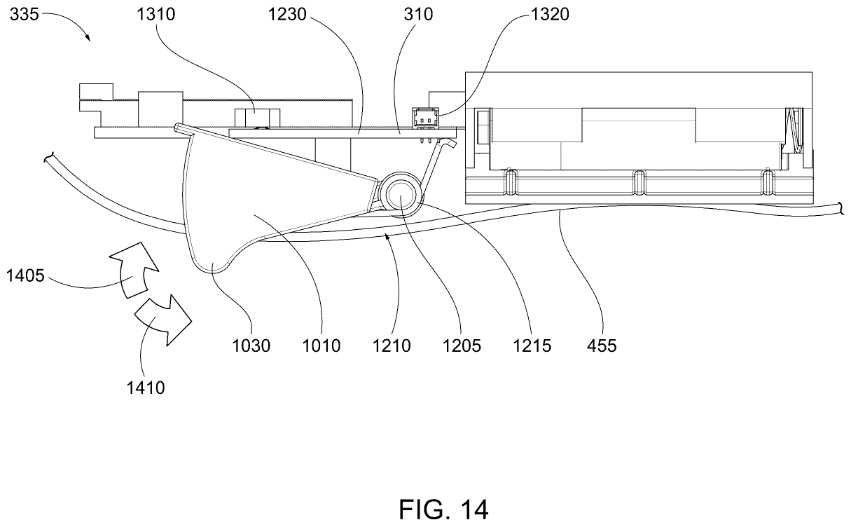

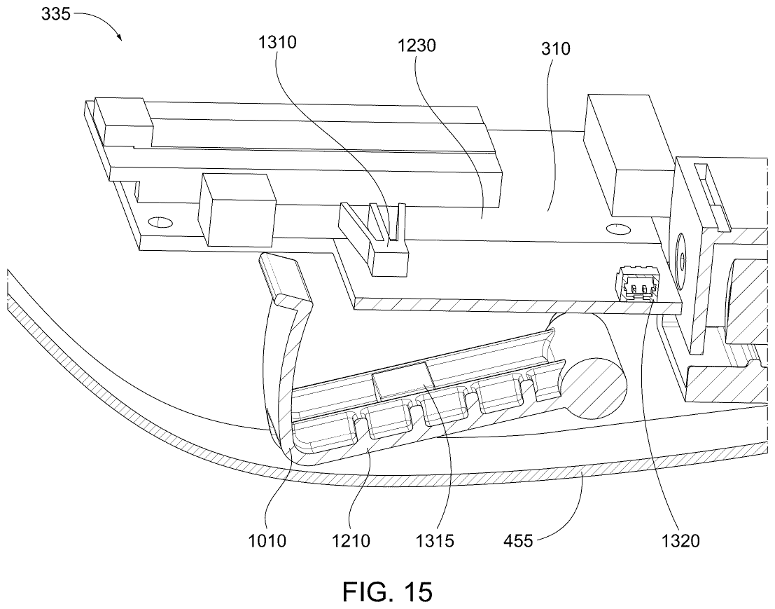

Turning to FIGS. 14 and 15, when tension is applied to the harness adjuster strap 455, the tension arm 1010 pivots about the shaft 1205 against the force of the torsion spring 1215 as is indicated by arrow 1405 in FIG. 14. As the magnet 1315 on the tension arm 1010 moves closer to the magnetic sensor 1310 on the circuit board 1230, the magnetic sensor 1310 senses a stronger magnetic field. The processor 330 of the controller 310 correlates the stronger magnetic field to a stronger tension being applied to the harness 425. Once a specified tension (or magnetic field) strength limit is reached in one version, the processor 330 of the controller 310 illuminates the tension indicator 625 to indicate that the proper tension is being applied (e.g., shines a green light). In another variation, the color and/or brightness of the tension indicator 625 changes depending on the amount of tension being applied to the harness adjuster strap 455.

Conversely, when the tension in the harness adjuster strap 455 is released, such as when the cam buckle 460 is actuated to release the harness adjuster strap 455, the spring 1210 of the tension sensor 335 pivots the magnet 1315 on the tension arm 1010 away from the magnetic sensor 1310 as is indicated by arrow 1410 in FIG. 14. This causes the magnetic sensor 1310 to sense a weaker magnetic field. The processor 330 of the controller 310 interprets the weaker magnetic field to weaker tension being applied to the harness 425. Once the tension is below the limit, the processor 330 of the controller 310 illuminates the tension indicator 625 to indicate that improper tension is being applied (e.g., shines a red light). Once more, the color and/or brightness of the tension indicator 625 in other variations changes depending on the amount of tension being applied to the harness adjuster strap 455. For instance, the tension indicator 625 can progress in a fashion similar to a traffic light where green signifies proper tension, yellow signifies there is too low of tension, and red signifies no tension in the harness 425. Of course, other indicator schemes can be used in other examples.

### GLOSSARY OF TERMS

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“Buckle” generally refers to device, such as in the form of a clasp, that releasably secures two or more loose ends together. Typically, but not always one end is secured to or otherwise attached to the clasp device, and the other end is releasably or adjustably held by the clasp device. The ends can be for a variety of objects such as straps, belts, cables, and webbing, to name just a few. One common type of buckle is a seat belt buckle found in a wide variety of vehicles. For instance, the buckle can be used in two-point, three-point, four-point, five-point, or six-point harness systems. In one example, the loose end of a seat belt is looped through a slot in a latch plate that includes a tongue, and to secure the loose end, the tongue is inserted into a seat belt buckle that is attached to a fixed seat belt or webbing.

“Cam Buckle” generally refers to a device or mechanism that includes a frame and a cam (or jaw) pivotally coupled to the frame configured to lock a belt or webbing at a fixed position and/or length. The cam commonly, but not always, includes a lever or handle to allow a user to rotate the cam. The cam can be pivotally mounted to the frame in a number of ways such as through one or more pins and/or a shaft. In one use case example, a free end of the belt passes through a clearance or gap between the frame and the cam. When the cam is rotated relative to the frame, the size of the clearance gap between the cam and frame changes. For instance, rotating the cam in one direction reduces the clearance gap, and rotating the cam in the opposite direction increases the clearance gap. As an example, when the cam is rotated to a closed or locked position, the clearance gap between the cam and the frame is reduced such that the cam bites against the belt to clamp the belt between the cam and frame. In some designs, the cam has a knurled or serrated gripping surface configured to bite against the belt, and in other designs, the gripping surface can be generally smooth or have other types of textures. As tension is applied to the belt, the cam is configured to further rotate which in turn reduces the clearance so as to increasing the biting force applied by the cam against the belt. To release the belt, the cam is rotated in the opposite to an opened or unlocked (released) position, the clearance gap between the cam and the frame increases to such a point where the cam no longer grips or bite into the belt. When the cam is in the opened position, the belt is able to slide relative to the cam buckle such that the belt can even be removed from the cam buckle. In some design configurations, the cam buckle further includes a spring or other biasing device that biases the cam to either the opened or closed position. In one design variation, the spring is coupled between the cam and frame so as to bias the cam to the closed position where the belt is locked in place. In such a case, the user presses against or otherwise actuates the lever of the cam to release the belt. The cam buckle can be made from a variety of materials such as metal and/or plastic, and the cam buckle can come in a variety of shapes, sizes, and types. Cam buckles can be used in a large number of ways such as for securing equipment, child safety seats, or even belts for clothing. For example, one type of cam buckle for child restraint systems is sold under the brand A-LOK® by Indiana Mills and Manufacturing, Inc. (IMMI).

“Camera” generally refers to a device that records visual images. Typically, a camera may record two-and/or three-dimensional images. In some examples, images are recorded in the form of film, photographs, image signals, and/or video signals. A camera may include one or more lenses or other devices that focus light onto a light-sensitive surface, for example a digital light sensor or photographic film. The light-sensitive surface may react to and be capable of capturing visible light or other types of light, such as infrared (IR) and/or ultraviolet (UV) light.

“Child Safety Seat”, “Car Seat”, or “Child Restraint System (CRS)” generally refer to a seat that is specifically designed to protect children from injury during a vehicle collision. Commonly, the child safety seat is an aftermarket product that is installed by an owner into a vehicle after purchase of the vehicle, but the child safety seat can be also integrated into a seat of the vehicle by a manufacturer of the vehicle. In contrast to most vehicle seats, which are designed to accommodate adults, the child safety seat is sized and configured to properly position a child or infant to reduce injury during an accident. The child safety seat further typically includes a passive restraint system, such as a harness, that generally holds an occupant of the seat in place during a collision. The restraint system for example can include a five-point harness, but other types of harnesses and restraints can be used. When sold as a separate, aftermarket product, the child safety seat can include an anchoring mechanism, like an Isofix connector, configured to secure the child safety seat to the vehicle (e.g., via an Isofix anchor in the vehicle). Some typical types of child safety seats include infant seats, convertible seats, combination seats, and booster seats, just to name a few.

“Conductor” or “Conductive Material” generally refers to a material and/or object that allows the free flow of an electrical charge in one or more directions such that relatively significant electric currents will flow through the material under the influence of an electric field under normal operating conditions. By way of non-limiting examples, conductors include materials having low resistivity, such as most metals (e.g., copper, gold, aluminum, etc.), graphite, and conductive polymers.

“Controller” generally refers to a device, using mechanical, hydraulic, pneumatic electronic techniques, and/or a microprocessor or computer, which monitors and physically alters the operating conditions of a given dynamical system. In one non-limiting example, the controller can include an Allen Bradley brand Programmable Logic Controller (PLC). A controller may include a processor for performing calculations to process input or output. A controller may include a memory for storing values to be processed by the processor, or for storing the results of previous processing. A controller may also be configured to accept input and output from a wide array of input and output devices for receiving or sending values. Such devices include other computers, keyboards, mice, visual displays, printers, industrial equipment, and systems or machinery of all types and sizes. For example, a controller can control a network or network interface to perform various network communications upon request. The network interface may be part of the controller or characterized as separate and remote from the controller. A controller may be a single, physical, computing device such as a desktop computer, or a laptop computer, or may be composed of multiple devices of the same type such as a group of servers operating as one device in a networked cluster, or a heterogeneous combination of different computing devices operating as one controller and linked together by a communication network. The communication network connected to the controller may also be connected to a wider network such as the Internet. Thus, a controller may include one or more physical processors or other computing devices or circuitry and may also include any suitable type of memory. A controller may also be a virtual computing platform having an unknown or fluctuating number of physical processors and memories or memory devices. A controller may thus be physically located in one geographical location or physically spread across several widely scattered locations with multiple processors linked together by a communication network to operate as a single controller. Multiple controllers or computing devices may be configured to communicate with one another or with other devices over wired or wireless communication links to form a network. Network communications may pass through various controllers operating as network appliances such as switches, routers, firewalls or other network devices or interfaces before passing over other larger computer networks such as the Internet. Communications can also be passed over the network as wireless data transmissions carried over electromagnetic waves through transmission lines or free space. Such communications include using Wi-Fi or other Wireless Local Area Network (WLAN) or a cellular transmitter/receiver to transfer data.

“Current” generally refers to the rate of flow of electric charge past a point or region of an electric circuit. An electric current is said to exist when there is a net flow of electric charge through a region.

“Energy Storage System” (ESS) or “Energy Storage Unit” generally refers to a device that captures energy produced at one time for use at a later time. The energy can be supplied to the ESS in one or more forms, for example including radiation, chemical, gravitational potential, electrical potential, electricity, elevated temperature, latent heat, and kinetic types of energy. The ESS converts the energy from forms that are difficult to store to more conveniently and/or economically storable forms. By way of non-limiting examples, techniques for accumulating the energy in the ESS can include: mechanical capturing techniques, such as compressed air storage, flywheels, gravitational potential energy devices, springs, and hydraulic accumulators; electrical and/or electromagnetic capturing techniques, such as using capacitors, super capacitors, and superconducting magnetic energy storage coils; biological techniques, such as using glycogen, biofuel, and starch storage mediums; electrochemical capturing techniques, such as using flow batteries, rechargeable batteries, and ultra batteries; thermal capture techniques, such as using eutectic systems, molten salt storage, phase-change materials, and steam accumulators; and/or chemical capture techniques, such as using hydrated salts, hydrogen, and hydrogen peroxide. Common ESS examples include lithium-ion batteries and super capacitors.

“Gap” generally refers to a space between objects, surfaces, or points.

“Harness” generally refers to a set of straps and fittings for fastening a human or other animal in a particular place and/or position. The straps can come on many forms, such as belts, webbing, or ropes, and the straps can be made of a variety of materials such as natural or synthetic materials. The fittings are designed in a variety of forms for securing the straps around the individual as well as releasing the straps to free the individual. The harness can include webbing, buckles, latch plates, and/or length-adjustment mechanisms, such as a retractor. In one example, the fitting includes a set of latch plates that are secured in a buckle release mechanism. Harnesses can for instance be integrated into vehicle seats, child booster seats, and child safety seats. The straps and fitting can be configured in a number of manners such as to form three-point, five-point, and six-point harnesses, to name just a few examples.

“Harness Adjuster” generally refers to a device used to tighten and loosen a harness. The harness adjuster can be used to tighten a wide variety of harnesses, such as those used in vehicles. Commonly the harness adjusters are used in child safety seats, but the harness adjuster can have other use cases like for harnesses that secure adults. The harness adjuster can be located at a variety of locations. For instance, the harness adjuster can be located on the back of the seat, on the side of the seat, on the harness itself, and/or between the legs of a seat occupant.

“Harness Adjuster Strap” or “Harness Adjuster Belt” generally refers to a single piece of belt or webbing used to tighten a harness. In one common design, the harness adjuster strap is coupled to a harness adjuster configured to loosen or tighten the harness adjuster strap. In this design, the other end of the harness adjuster strap is coupled to a splitter plate which in turn is coupled to one or more belts of the harness.

“Headrest” or “Head Restraint” generally refers to a structure attached or otherwise integrated into the top of a seat to limit the rearward movement of the head of the seat occupant, relative to the torso, in a collision. For instance, the headrest is designed to prevent or mitigate whiplash or other injury to the cervical vertebrae. The headrest can include a fixed headrest or an adjustable headrest. The adjustable headrest is capable of being positioned to fit the morphology of the seated occupant. The adjustable headrest can be adjusted manually and/or automatically. Another type of headrest includes an active head restraint designed to automatically improve head restraint position and/or geometry for the seat occupant during a collision.

“Hole” generally refers to a hollow portion through a solid body, wall, or a surface. A hole may be any shape. For example, a hole may be, but is not limited to, circular, triangular, or rectangular. A hole may also have varying depths and may extend entirely through the solid body or surface or may extend through only one side of the solid body.

“Housing” generally refers to a component that covers, protects, or supports another thing. For example, the casing of a desktop computer is its housing component and can be made of multiple materials to protect the internal component.

“Input Device” generally refers to any device coupled to a computer that is configured to receive input and deliver the input to a processor, memory, or other part of the computer. Such input devices can include keyboards, mice, trackballs, and touch sensitive pointing devices such as touchpads or touchscreens. Input devices also include any sensor or sensor array for detecting environmental conditions such as temperature, light, noise, vibration, humidity, and the like.

“Input/Output (I/O) Device” generally refers to any device or collection of devices coupled to a computing device that is configured to receive input and deliver the input to a processor, memory, or other part of the computing device and/or is controlled by the computing device to produce an output. The I/O device can include physically separate input and output devices, or the input and output devices can be combined together to form a single physical unit. Such input devices of the I/O device can include keyboards, mice, trackballs, and touch sensitive pointing devices such as touchpads or touchscreens. Input devices also include any sensor or sensor array for detecting environmental conditions such as temperature, light, noise, vibration, humidity, and the like. Examples of output devices for the I/O device include, but are not limited to, screens or monitors displaying graphical output, a projecting device projecting a two-dimensional or three-dimensional image, or any kind of printer, plotter, or similar device producing either two-dimensional or three-dimensional representations of the output fixed in any tangible medium (e.g., a laser printer printing on paper, a lathe controlled to machine a piece of metal, or a three-dimensional printer producing an object). An output device may also produce intangible output such as, for example, data stored in a database, or electromagnetic energy transmitted through a medium or through free space such as audio produced by a speaker controlled by the computer, radio signals transmitted through free space, or pulses of light passing through a fiber-optic cable.

“Insulator” or “Insulative Material” generally refers to a material and/or object whose internal electric charges do not flow freely such that very little electric current will flow through the material under the influence of an electric field under normal operating conditions. By way of non-limiting examples, insulator materials include materials having high resistivity, such as glass, paper, ceramics, rubber, and plastics.

“Integrally Formed” generally refers to a component and/or multiple components that are fused into a single piece. Integrally formed components are incapable of being dismantled without destroying the integrity of the component.

“Latch Plate” generally refers to a part of a vehicle belt assembly that releasably connects to a buckle and through which the belt or webbing is threaded or otherwise secured. Typically, but not always, the latch plate is at least in part made of metal and/or plastic. The latch plate includes one or more tongues that are inserted into the buckle. Each tongue can include a notch or other opening that is used to secure the latch plate to the buckle. By way of non-limiting examples, the latch plates can include free-sliding latch plates, cinching latch plates, locking latch plates, and switchable latch plates, to name just a few examples.

“Lateral” generally refers to being situated on, directed toward, or coming from the side.

“Light Emitting Diode” or “LED” generally refers to a semiconductor diode, made from certain materials, in which light is emitted in response to application of an electrical current. A variety of materials in the LED can produce a range of colors. The color of the light (corresponding to the energy of the photons) is determined by the energy required for electrons to cross the band gap of the semiconductor. Typically, but not always, white light is obtained by using multiple semiconductors or a layer of light-emitting phosphor on the semiconductor device. The LED can come in the form of a variety of colors, shapes, sizes and designs, including with or without heat sinking, lenses, or reflectors, built into the package.

“Lever” generally refers to a simple machine including a beam, rod, or other structure pivoted at a fulcrum, such as a hinge. In one form, the lever is a rigid body capable of rotating on a point on itself. Levers can be generally categorized into three types of classes based on the location of fulcrum, load, and/or effort. In a class 1 type of lever, the fulcrum is located in the middle such that the effort is applied on one side of the fulcrum and the resistance or load on the other side. For class 1 type levers, the mechanical advantage may be greater than, less than, or equal to 1. Some non-limiting examples of class 1 type levers include seesaws, crowbars, and a pair of scissors. In a class 2 type of lever, which is sometimes referred to as a force multiplier lever, the resistance or load is located generally near the middle of the lever such that the effort is applied on one side of the resistance and the fulcrum is located on the other side. For class 2 type levers, the load arm is smaller than the effort arm, and the mechanical advantage is typically greater than 1. Some non-limiting examples of class 2 type levers include wheelbarrows, nutcrackers, bottle openers, and automobile brake pedals. In a class 3 type lever, which is sometimes referred to as a speed multiplier lever, the effort is generally located near the middle of the lever such that the resistance or load is on one side of the effort and the fulcrum is located on the other side. For class 3 type levers, the effort arm is smaller than the load arm, and the mechanical advantage is typically less than 1. Some non-limiting examples of class 3 type levers include a pair of tweezers and the human mandible.

“Longitudinal” generally refers to the length or lengthwise dimension of an object, rather than across.

“Magnet” generally refers to a material or object that produces a magnetic field external to itself. Types of magnets include permanent magnets and electromagnets. By way of non-limiting examples, magnets in certain circumstances are able to attract (or repel) objects such as those made of iron or steel.

“Memory” generally refers to any storage system or device configured to retain data or information. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

“Microphone” generally refers to a transducer that converts sound into an electrical signal.

“Occupancy Sensor” or “OCS” generally refers to a device that determines whether or not and/or to what extent someone is sitting in a seat. Occupancy sensors are commonly found in vehicles to determine whether an air bag can be safely deployed, but seat occupancy sensors have other uses. Common types of occupancy sensors include weight sensors, pressure sensors, ultrasonic sensors, and infrared (IR) sensors. In addition to detecting the presence of a seat occupant sitting in the seat, the occupancy sensor can be configured to detect the weight or size of the seat occupant as well as if the seat occupant is sitting properly.

“Operatively Coupled” means connected such that current can flow between two devices. In addition, two devices having an optional resistor connecting them are considered to be operatively coupled.

“Optical Fiber” generally refers to an electromagnetic waveguide having an elongate conduit that includes a substantially transparent medium through which electromagnetic energy travels as it traverses the long axis of the conduit. Electromagnetic radiation may be maintained within the conduit by total internal reflection of the electromagnetic radiation as it traverses the conduit. Total internal reflection is generally achieved using optical fibers that include a substantially transparent core surrounded by a second substantially transparent cladding material with a lower index of refraction than the core.

“Output Device” generally refers to any device or collection of devices that is controlled by computer to produce an output. This includes any system, apparatus, or equipment receiving signals from a computer to control the device to generate or create some type of output. Examples of output devices include, but are not limited to, screens or monitors displaying graphical output, any projecting device projecting a two-dimensional or three-dimensional image, any kind of printer, plotter, or similar device producing either two-dimensional or three-dimensional representations of the output fixed in any tangible medium (e.g., a laser printer printing on paper, a lathe controlled to machine a piece of metal, or a three-dimensional printer producing an object). An output device may also produce intangible output such as, for example, data stored in a database, or electromagnetic energy transmitted through a medium or through free space such as audio produced by a speaker controlled by the computer, radio signals transmitted through free space, or pulses of light passing through a fiber-optic cable.

“Plastic” generally refers to a synthetic or semi-synthetic material made from a wide range of organic polymers, such as polyethylene, PVC, nylon, and the like. Typically, but not always, plastics are mostly thermoplastic or thermosetting polymers of high molecular weight and that can be made into objects, films, or filaments. In some cases, plastics can be molded into shape while soft and then set into a rigid or slightly elastic form.

“Processor” generally refers to one or more electronic components configured to operate as a single unit configured or programmed to process input to generate an output. Alternatively, when of a multi-component form, a processor may have one or more components located remotely relative to the others. One or more components of each processor may be of the electronic variety defining digital circuitry, analog circuitry, or both. In one example, each processor is of a conventional, integrated circuit microprocessor arrangement. The concept of a “processor” is not limited to a single physical logic circuit or package of circuits but includes one or more such circuits or circuit packages possibly contained within or across multiple computers in numerous physical locations. In a virtual computing environment, an unknown number of physical processors may be actively processing data, and the unknown number may automatically change over time as well. The concept of a “processor” includes a device configured or programmed to make threshold comparisons, rules comparisons, calculations, or perform logical operations applying a rule to data yielding a logical result (e.g., “true” or “false”). Processing activities may occur in multiple single processors on separate servers, on multiple processors in a single server with separate processors, or on multiple processors physically remote from one another in separate computing devices.

“Seat assembly” generally refers to all the component parts that make up a seat within a vehicle. A seat assembly generally includes a seat back and a seat bottom.

“Seat Back” generally refers to the portion of a seat intended to support the back of a passenger. The seat back generally includes a housing, a panel, and a frame. In some instances, the seat back is outfitted with safety features, such as buckle assemblies and/or child safety seats.

“Seat Belt”, “Safety Belt”, “Vehicle Belt”, or “Belt” generally refers to an arrangement of webs, straps, and other devices designed to restrain or otherwise hold a person or other object steady such as in a boat, vehicle, aircraft, and/or spacecraft. For example, the seat belt is designed to secure an occupant of a vehicle against harmful movement that may result during a collision or a sudden stop. By way of non-limiting examples, the seat belt can include webbing, buckles, latch plates, and/or length-adjustment mechanisms, such as a retractor, installed in the vehicle that is used to restrain an occupant or a child restraint system. The seat belt for instance can include a lap belt only, a combination lap-shoulder belt, a separate lap belt, a separate shoulder belt, and/or a knee bolster.

“Seat Bottom” generally refers to the portion of a seat that a passenger sits on and the mounting structure, such as mounting pedestals, for securing the seat assembly to the vehicle.

“Sensor” generally refers to an object whose purpose is to detect events and/or changes in the environment of the sensor, and then provide a corresponding output. Sensors include transducers that provide various types of output, such as electrical and/or optical signals. By way of nonlimiting examples, the sensors can include pressure sensors, ultrasonic sensors, humidity sensors, gas sensors, motion sensors, acceleration sensors, displacement sensors, force sensors, optical sensors, and/or electromagnetic sensors. In some examples, the sensors include barcode readers, RFID readers, and/or vision systems.

“Shaft” generally refers to a part that rotates about a central axis. Shafts are a part of various mechanically rotating devices, such as motors, engines, transmissions, gearsets, and/or other devices. Shafts are usually, but not always, used to transfer mechanical torque between various mechanical components. For example, the shaft of a motor may transfer energy to a transmission, an axle, a wheel, and/or another device. In some cases, the shaft of a device is integrated with other parts of that device. The shaft can be shaped in any number of manners. For instance, the shaft can have a cylindrical or rectangular shape, and the shaft can be hollow or solid.

“Splitter Plate” generally refers to a component that connects one or more belts of a harness to a harness adjuster strap. Typically, the splitter plate is made of strong material, such as metal, but the splitter plate can be made from other materials. In one version, the splitter plate is a metal piece on the back of a car seat that attaches the ends of two shoulder belts of the harness to the harness adjuster strap. In another variation, a single belt that acts as one or more shoulder straps is looped through the splitter plate.

“Spring” generally refers to an elastic object that stores mechanical energy. The spring can include a resilient device that can be pressed, pulled, and/or twisted but returns to its former shape when released. The spring can be made from resilient or elastic material such as metal and/or plastic. The spring can counter or resist loads in many forms and apply force at constant or variable levels. For example, the spring can include a tension spring, compression spring, torsion spring, constant spring, and/or variable spring. The spring can take many forms such as by being a flat spring, a machined spring, and/or a serpentine spring. By way of nonlimiting examples, the springs can include various coil springs, pocket springs, Bonnell coils, offset coils, continuous coils, cantilever springs, volute springs, hairsprings, leaf springs, V-springs, gas springs, leaf springs, torsion springs, rubber bands, spring washers, and/or wave springs, to name just a few.

“Terminal” generally refers to a plug, socket or other connection (male, female, mixed, hermaphroditic, or otherwise) for mechanically and electrically connecting two or more wires or other conductors.

“Transceiver” generally refers to a device that includes both a transmitter and a receiver that share common circuitry and/or a single housing. Transceivers are typically, but not always, designed to transmit and receive electronic signals, such as analog and/or digital radio signals.

“Voltage” generally refers to a difference in electric potential between two points. A given voltage value must reference another point such as a ground or neutral point as examples. Voltage can be the result of electric charge build-up, electromagnetic induction, electrochemical processes, piezoelectric effects, or thermoelectric effects as examples.

“Web” generally refers to a material made of a network of thread, strings, cords, and/or wires that form openings in-between. In one form, the cords are interlaced or woven together. The interlaced pattern can be uniform or random.

“Wire” generally refers to a long thin piece of metal usually drawn out into the form of a flexible thread, strand, or slender rod.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

### REFERENCE NUMBERS

100 smart buckle system
102 microprocessor
104 transceiver
108 buckle
110 camera
120 indicator lights
130 microphone
140 connector
150 load sensor
160 temperature sensor
170 tension sensor
180 thermal sensing electronic device
190 external power source
195 external enclosure
197 webbing
198 wire
300 seat monitoring system
305 buckle
310 controller
315 occupancy sensor
320 buckle sensor
325 output device
330 processor
335 tension sensor
340 memory
345 ESS
350 buckle wire
355 occupancy sensor wire
400 child safety seat
405 seat assembly
410 seat back
415 seat bottom
420 restraint system
425 harness
430 belts
435 latch plates
440 buckle belt
445 release button
450 harness adjuster
455 harness adjuster strap
460 cam buckle
505 splitter plate
605 indicator lights
610 LEDs
615 buckle indicator
620 occupancy indicator
625 tension indicator
805 micro switch
810 hinged spring
815 tongues
820 arrow
905 housing
1005 strap guides
1010 tension arm
1015 guide arms
1020 guide slot
1025 gap
1030 guide flanges
1205 shaft
1210 spring
1215 torsion spring
1220 guide surface
1225 guide channel
1230 circuit board
1235 batteries
1305 sensor
1310 magnetic sensor
1315 magnet
1320 terminal
1405 arrow
1410 arrow

What is claimed is:

1. A system, comprising:
a harness;
a buckle;
a buckle sensor being configured to monitor status of the buckle;
a harness adjuster being configured to adjust tension of the harness;
a tension sensor being configured to monitor tension to the harness applied by the harness adjuster;
an output device being located on the buckle;
wherein the output device is configured to provide the status of the buckle; and
wherein the output device is configured to provide an indication of the tension of the harness.

2. The system of claim 1, wherein:
the harness includes one or more latch plates;
each of the latch plates include a tongue; and
the tongue of at least one of the latch plates is configured to contact the buckle sensor when latched to the buckle.

3. The system of claim 2, wherein:
the buckle sensor includes a micro switch;
the micro switch includes a hinged spring; and
the hinged spring being configured to close the micro switch when the tongue presses against the hinged spring when latched.

4. The system of claim 2, further comprising:
a child safety seat;
a seat monitoring system including a controller;
a buckle wire operatively coupling the buckle sensor to the controller;
wherein the buckle has a buckle belt;
wherein the buckle belt secures the buckle to the child safety seat; and
wherein the buckle wire is embedded in the buckle belt.

5. The system of claim 4, further comprising:
wherein the controller is mounted on a back side of the child safety seat; and
wherein the buckle wire extends from the buckle to the back side of the child safety seat via the buckle belt.

6. The system of claim 1, further comprising:
a seat monitoring system including a controller; and
wherein the tension sensor is housed in the controller.

7. The system of claim 1, wherein:
the harness adjuster includes a harness adjuster strap; and
the harness adjuster strap extends along the tension sensor.

8. The system of claim 7, wherein:
the tension sensor includes a tension arm;
the harness adjuster strap is configured to pivot the tension arm when tension is applied; and
the tension sensor is configured to sense the tension in the harness adjuster strap when the tension arm pivots.

9. The system of claim 8, wherein:
the tension sensor includes a shaft upon which the tension arm is pivotally mounted; and
the tension sensor includes a spring configured to bias the tension arm against the harness adjuster strap.

10. The system of claim 9, further comprising:
a magnet mounted to the tension arm;
wherein the tension sensor includes a magnetic sensor; and
wherein the magnetic sensor is configured to measure the magnetic field from the magnet to determine the tension in the harness.

11. The system of claim 8, wherein:
the tension sensor includes one or more strap guides; and
the strap guides are configured to guide the harness adjuster strap across the tension arm.

12. The system of claim 11, wherein the strap guides are positioned on opposite sides of the tension arm.

13. The system of claim 8, wherein:
the tension arm has one or more guide flanges; and
the guide flanges define a guide channel where the harness adjuster strap is received.

14. The system of claim 1, wherein the output device includes one or more indicator lights.

15. The system of claim 14, wherein:
the indicator lights include a buckle indicator light; and
the buckle indicator light is configured to indicate status of the buckle.

16. The system of claim 14, wherein:
the indicator lights include a tension indicator light; and
the tension indicator light indicates the level of tension in the harness.

17. The system of claim 14, wherein the indicator lights include light emitting diodes (LEDs).

18. The system of claim 14, further comprising:
a seat bottom;
an occupancy sensor (OCS);
wherein the occupancy sensor is located in the seat bottom;
wherein the occupancy sensor is configured to sense if someone is sitting; and
wherein the indicator lights include an occupancy indicator light.

19. The system of claim 1, wherein:
the harness includes one or more latch plates;
the buckle includes a release button configured to release the latch plates from the buckle; and
the output device is located proximal to the release button of the buckle to enhance visibility.

20. A system, comprising:
a harness;
a harness adjuster being configured to adjust tension of the harness;
a harness adjuster includes a harness adjuster strap;
a tension sensor being configured to monitor tension of the harness; and
wherein the harness adjuster strap extends along the tension sensor.

21. The system of claim 20, wherein:
the tension sensor includes a tension arm;
the harness adjuster strap is configured to pivot the tension arm when tension is applied; and
the tension sensor is configured to sense the tension in the harness adjuster strap when the tension arm pivots.

22. The system of claim 21, wherein:
the tension sensor includes a shaft upon which the tension arm is pivotally mounted; and
the tension sensor includes a spring configured to bias the tension arm against the harness adjuster strap.

23. The system of claim 22, wherein:
the tension sensor includes a magnetic sensor;
the magnet mounted to the tension arm; and
the magnetic sensor is configured to measure the magnetic field from the magnet to determine the tension in the harness.

24. The system of claim 21, wherein:
the tension sensor includes one or more strap guides; and
the strap guides are configured to guide the harness adjuster strap across the tension arm.

25. The system of claim 24, wherein the strap guides are positioned on opposite sides of the tension arm.

26. The system of claim 25, where the strap guides have guide arms that define a guide slot where the harness adjuster strap is received.

27. The system of claim 26, wherein the guide arms define a gap.

28. The system of claim 24, wherein:
the tension arm has one or more guide flanges; and
the guide flanges define a guide channel where the harness adjuster strap is received.

29. The system of claim 21, wherein:
the tension sensor includes a magnetic sensor;
the magnet mounted to the tension arm; and
the magnetic sensor is configured to measure the magnetic field from the magnet to determine the tension in the harness.

30. The system of claim 20, wherein the harness adjuster includes a cam buckle configured to secure the harness adjuster strap.

31. The system of claim 20, further comprising:
a buckle;
wherein the harness includes one or more belts;
wherein the harness includes one or more latch plates;
wherein the latch plates are configured to be detachably secured to the buckle;
an output device being located on the buckle; and
wherein the output device is configured to provide an indication of the tension of the harness.

32. The system of claim 31, further comprising:
a buckle sensor being configured to monitor status of the buckle; and
wherein the output device is configured to provide the status of the buckle.

33. A method, comprising:
detecting buckling of a harness with a buckle sensor;
providing with an output device a buckle indication in response to the detecting buckling;
measuring tension of the harness with a tension sensor; and
providing with the output device a tension indication that corresponds with the tension of the harness.

34. The method of claim 33, further comprising:
determining a seat was occupied with an occupancy sensor; and
providing with the output device an occupancy indication.
